(19) United States
(12) Patent Application Publication
(10) Pub. No.: US 2013/0045326 A1
(43) Pub. Date: Feb. 21, 2013

(54) Jalapeno Flavored Food Enhancer

(71) Applicant: Eyad Hajeer, El Paso, TX (US)

(72) Inventor: Eyad Hajeer, El Paso, TX (US)

(21) Appl. No.: 13/213,402

(22) Filed: Aug. 19, 2011

(51) Int. Cl. A23L 1/222

(52) U.S. Cl. 426/638

(57) ABSTRACT

The method of preparation for a jalapeno flavored food enhancer comprising the steps of placing a plurality of ingredients into a container; adding an edible oil to the container; setting the container with the plurality of ingredients and edible oil aside for a predetermined amount of time; mixing contents of the container; pouring the contents of the container into a jar; topping the jar with edible oil; and vacuum sealing the jar once the jar is filled. The plurality of ingredients may include jalapenos, chipotle peppers, sun dried tomatoes, oregano, salt, sumac spice, garlic, and red peppers combined to create a spicy and delicious food condiment.

### BACKGROUND OF THE INVENTION

1. Field of the Invention

The present invention relates to a food enhancer that may be introduced onto a food product to add a spicy and delicious flavoring to the food product.

2. Description of Related Art

Condiments are available in all sorts of varieties such as savory, sweet, spicy, tart or any combination thereof. Recently, spicy food enhancers like salsa, hot sauce and rubs have become increasingly popular. The spicy food enhancers may be used as marinades, dips, toppings and coatings for a wide variety of foods ranging from chicken wings, steaks, chips, pizza and atop whatever else the consume may desire a spicy kick. Even the pickiest palettes search for their favorite spicy flavorings, trying to find the perfect combination for their particular needs.

Since individuals who enjoy zesty and hot flavors are constantly searching for new products within the culinary condiment spectrum, there is a desire in the art to create the next sensational spicy flavor combination. Therefore, it would be beneficial in the art to combine the spicy qualities of peppers, such as jalapenos or chipotles, the sweet qualities of sun dried tomatoes and the tartness of sumac spice to create a unique and interesting flavor enhancer, suitable for any food of the user's choosing.

### SUMMARY OF THE INVENTION

In view of the foregoing disadvantages inherent in the prior art, the general purpose of the present invention is to provide a jalapeno flavored food enhancer, configured to include all of the advantages of the prior art, and to overcome the drawbacks inherent therein.

Accordingly, an object of the present invention is to provide a spicy food condiment combining such ingredients as jalapenos, chipotles, sun dried tomatoes, oregano, sumac, garlic, salt and red pepper.

Another object of the present invention is to provide a method of creating the spicy condiment by combining the ingredients, and letting them impart their flavoring into an edible oil by setting the mixture aside for a predetermined amount of time.

To achieve the above objects, in an aspect of the present invention, a jalapeno flavored food enhancer is described comprising the steps of placing a plurality of ingredients into a container; adding an edible oil to the container; setting the container with the plurality of ingredients and the edible oil aside for a predetermined amount of time; mixing contents of the container; pouring the contents of the container into a jar; topping the jar with the edible oil; and vacuum sealing the jar once the jar is filled. The plurality of ingredients may include jalapenos, chipotle peppers, sun dried tomatoes, oregano, salt, sumac spice, garlic, and red peppers combined to create a spicy and delicious food condiment.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of a method of preparation for a jalapeno flavored food enhancer in accordance with an exemplary embodiment of the present invention.

### DETAILED DESCRIPTION OF THE DRAWINGS

The present invention relates to a condiment added to a food product to add a spicy and delicious flavoring to the food product. The present invention provides a jalapeno flavored food enhancer that may be added to many different foods for a spicy kick on the tongue of a consumer. The jalapeno flavored food enhancer includes ingredients such as jalapenos, chipotles, sun dried tomatoes, oregano, sumac spice, garlic, red pepper powder, sea salt and olive oil. The variety of flavorings adds a unique and great tasting topping that may be added to a plethora of food items. The jalapeno flavored food enhancer may be prepackaged in jars and sold to consumers, providing them with a delightfully spicy flavor condiment.

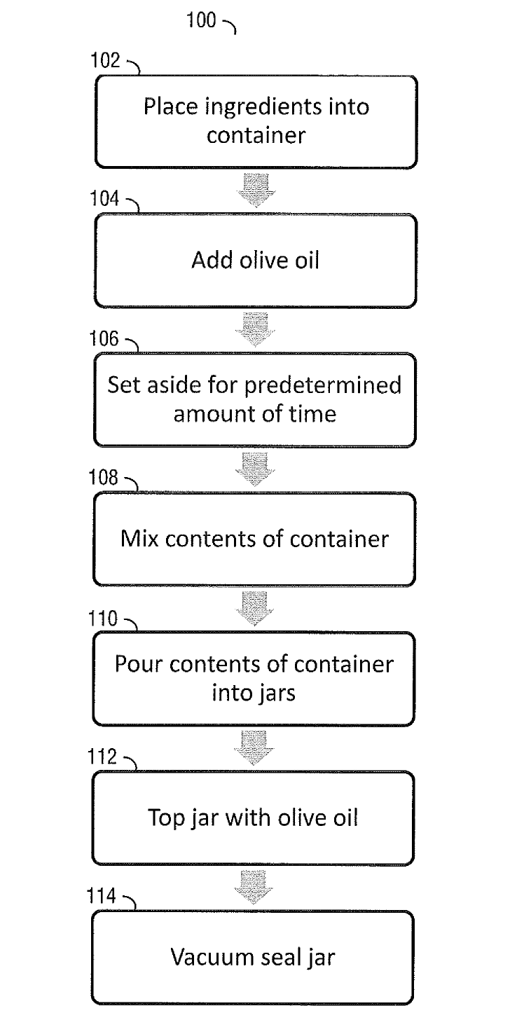

Turning now descriptively to the drawings, referring to FIG. 1, a perspective view of a method of preparation for a jalapeno flavored food enhancer (100) is shown in accordance with an exemplary embodiment of the present invention. The method of preparation (100) may begin by first combining a plurality of ingredients into a container (102). The plurality of ingredients may include jalapenos ranging from 4-12 cups, chipotle peppers ranging from ¼-¾ cups, sun dried tomatoes ranging from ¼-¾ cups, oregano ranging from ½-1½ cups, salt ranging from 2-6 tablespoons, sumac spice ranging from ¼-¾ cups, garlic ranging from ¼-¾ cups, red peppers ranging from ¼-¾ cups, and an edible oil. The jalapenos and chipotles may be whole or diced. The oregano may be fresh or dry. The salt may be table salt, sea salt or another variety of edible salt. The garlic may be whole cloves, minced, chopped, powdered or paste. The red peppers may be dried flakes or powered. The preferred types of ingredients and measurements are as follows:

| | | |
|---|---|---|
| Jalapenos | 8 | cups |
| Chipotle peppers | ½ | cup |
| Sun Dried Tomatoes | ½ | cup |
| Uncrushed Dried Oregano | 1 | cup |
| Sea Salt | ¼ | cup |
| Sumac | ⅓ | cup |
| Blended Garlic | ⅓ | cup |
| Powdered Red Peppers | ⅓ | cup |

Continuing with the method of preparation (100), after placing the plurality of ingredients into the container (102), the user may then add an edible oil (104) to a level that fills the container to reach the top of the ingredients. The edible oil may be olive oil, sunflower oil, safflower oil, canola oil, peanut oil, walnut oil or another oil variety commonly used in infusions or dressings. Preferably, olive oil is used. Next, the user sets the container with the ingredients and edible oil aside for a predetermined amount of time (106). The predetermined amount of time may range from a day to a month, preferably a week, to allow the ingredients to combine and for the flavors to absorb into the edible oil. After waiting the predetermined amount of time, the contents of the container (the ingredients and the edible oil) are mixed (108) or blended to thoroughly combine the flavors. The contents of the container are then poured into jars (110). The jars may be glass jars, suitable for canning, and may range in size from 4-24 ounces. Once the ingredients are in the jars more of the edible oil is added to top the jar (112). Finally, a lid is added to the jar, and the jar is vacuum sealed (114). By vacuum sealing the jar, the jalapeno flavored flavor enhancer may be preserved for an extended period of time, fresh and ready for when the user wishes to consume the product. As such, the formula of specifically chosen ingredients and method of preparation allows for the creation of a delectably spicy flavoring for edible enjoyment.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. The method of preparation for a jalapeno flavored food enhancer comprising the steps of:
combining a plurality of ingredients into a container, where the plurality of ingredients includes jalapenos, chipotle peppers, tomatoes, oregano, garlic, sun dried tomatoes, sumac, red peppers and sea salt;
adding an edible oil to the container;
setting the container with the plurality of ingredients and the edible oil aside for a predetermined amount of time; and
mixing contents of the container after expiration of the predetermined amount of time.

2. The method of preparation for a jalapeno flavored food enhancer according to claim 1, further comprising the step of pouring the contents of the container into a jar after the step of mixing.

3. The method of preparation for the jalapeno flavored food enhancer according to claim 2 further comprising the step of topping the jar with the edible oil after pouring the contents into the jar.

4. The method of preparation for the jalapeno flavored food enhancer according to claim 2 further comprising the step of vacuum sealing the jar once the jar is filled.

5. A jalapeno flavored food enhancer comprising:
a plurality of ingredients, where the plurality of ingredients include jalapenos, garlic, sun dried tomatoes, and salt; and
edible oil, where the edible oil receives the plurality of ingredients to enable the plurality of ingredients to impart their flavor into the edible oil.

6. The jalapeno flavored food enhancer according to claim 5, wherein the plurality of ingredients further includes sumac spice.

7. The jalapeno flavored food enhancer according to claim 5, wherein the plurality of ingredients further includes oregano.

8. The jalapeno flavored food enhancer according to claim 5, wherein the plurality of ingredients further includes red peppers.

9. The jalapeno flavored food enhancer according to claim 5, wherein the plurality of ingredients further includes chipotle peppers.
